(19) United States
(12) Patent Application Publication
(10) Pub. No.: US 2023/0393391 A1
(43) Pub. Date: Dec. 7, 2023

(54) DISPLAY DEVICE AND HEAD-UP DISPLAY

(71) Applicant: Panasonic Intellectual Property Management Co., Ltd., Osaka (JP)

(72) Inventors: Yutaka KUMANO, HYOGO KEN (JP); Kouzou YUUKI, OSAKA FU (JP); Yuji TAKASE, OSAKA FU (JP); Keiji SUGIYAMA, KYOTO FU (JP)

(73) Assignees: Panasonic Intellectual Property Management Co., Ltd., Osaka (JP); Panasonic Intellectual Property Management Co., Ltd., Osaka (JP)

(21) Appl. No.: 18/235,610

(22) Filed: Aug. 18, 2023

Related U.S. Application Data
(63) Continuation of application No. PCT/JP2021/038625, filed on Oct. 19, 2021.

(30) Foreign Application Priority Data
Mar. 31, 2021 (JP) 2021-059822

(51) Int. Cl. G02B 27/01; G02B 5/02; G02B 1/10

(52) U.S. Cl. CPC G02B 27/0101; G02B 5/0278; G02B 1/10

(57) ABSTRACT

A display device according to the present disclosure includes a display member, a light transmission member, a light diffusion member, and a plurality of protrusions. The display member has a display surface. The light transmission member is disposed on the display surface side of the display member, has a first surface on a side opposite to the display member and a second surface on the display member side, and has light transparency. The light diffusion member is disposed on a side opposite to the display surface of the display member, and has light diffusion. The plurality of protrusions is provided between the light transmission member and the display member.

### CROSS-REFERENCE TO RELATED APPLICATIONS

This application is a continuation of International Application No. PCT/JP2021/038625, filed on Oct. 19, 2021 which claims the benefit of priority of the prior Japanese Patent Application No. 2021-059822, filed on Mar. 31, 2021, the entire contents of which are incorporated herein by reference.

### FIELD

Embodiments described herein relate generally to a display device and a head-up display.

### BACKGROUND

JP 2017-83699 A discloses a display unit applied to a head-up display device. The display unit includes a display member and a light transmission member that is disposed on a display surface of the display member.

The present disclosure provides a display device and a head-up display, which can reduce the occurrence of Newton's rings.

### SUMMARY

A display device according to the present disclosure includes: a display member having a display surface; a light transmission member that is disposed on the display surface side of the display member, the light transmission member having light transparency and having a first surface on a side opposite to the display member and a second surface on the display member side; a light diffusion member that is disposed on a side opposite to the display surface of the display member, the light diffusion member having light diffusion; and a plurality of protrusions that is provided between the light transmission member and the display member.

A head-up display according to the present disclosure includes a display device and a projection optical system configured to project display light emitted from the display device onto a display medium. The display device includes: a display member having a display surface; a light transmission member that is disposed on the display surface side of the display member, the light transmission member having light transparency and having a first surface on a side opposite to the display member and a second surface on the display member side; a light diffusion member that is disposed on a side opposite to the display surface of the display member, the light diffusion member having light diffusion; and a plurality of protrusions that is provided between the light transmission member and the display member.

### BRIEF DESCRIPTION OF THE DRAWINGS

FIG. 1 is a diagram illustrating an automobile mounted with a head-up display including a display device in a first embodiment;

FIG. 2 is a diagram illustrating a field of view of a user when the head-up display including the display device in the first embodiment is used;

FIG. 3 is a diagram describing a structure of the head-up display including the display device in the first embodiment;

FIG. 4 is a schematic cross-sectional view of the display device in the first embodiment;

FIG. 5 is a schematic perspective view of the display device in the first embodiment;

FIG. 6 is an enlarged cross-sectional view of a part of a film member of the display device in the first embodiment;

FIG. 7 is a schematic cross-sectional view of a display device in a second embodiment;

FIG. 8 is an enlarged cross-sectional view of a part of a light transmission member of the display device in the second embodiment;

FIG. 9 is a schematic cross-sectional view of a display device in a third embodiment; and

FIG. 10 is an enlarged cross-sectional view of a part of a display member of the display device in the third embodiment.

### DETAILED DESCRIPTION

Embodiments will be described in detail below with reference to the drawings as appropriate. However, an unnecessarily detailed description may be omitted. For example, a detailed description of a matter already known well and a redundant description of substantially the same configuration may be omitted. This is intended to avoid making the following description unnecessarily redundant and to facilitate understanding by those skilled in the art.

Note that the accompanying drawings and the following description are provided for those skilled in the art to sufficiently understand the present disclosure, and are not intended to limit the subject matter described in the claims by the drawings and the description.

### First Embodiment

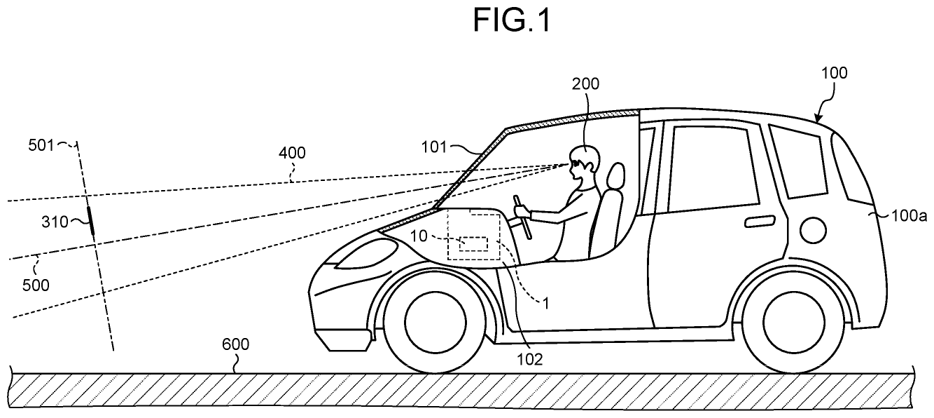

A first embodiment will be described below with reference to FIGS. 1 to 6.

Configuration of Automobile Using Head-Up Display

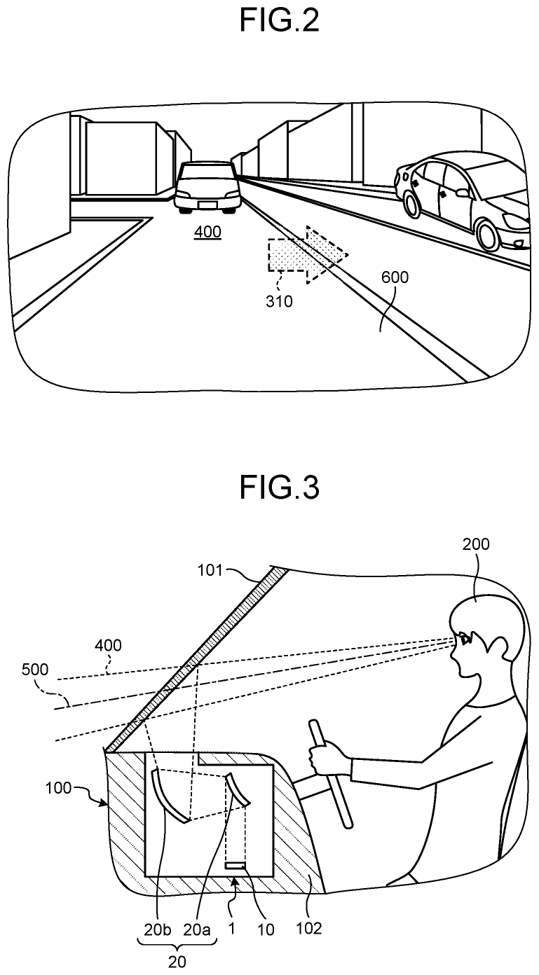

An automobile 100 using a head-up display 1 including a display device 10 will first be described with reference to FIGS. 1 and 2. The head-up display 1 is mounted on, as an example, a moving body. In the present embodiment, as illustrated in FIG. 1, a case where the moving body is the automobile 100 will be described as an example. The automobile 100 includes a vehicle body 100a as a moving body main body and the head-up display 1 mounted on the vehicle body 100a.

The head-up display 1 is installed in the vehicle interior of the automobile 100 so as to project an image from below onto a windshield 101 of the vehicle body 100a of the automobile 100. The head-up display 1 is disposed in a dashboard 102 below the windshield 101. When an image is projected from the head-up display 1 onto the windshield 101, the image reflected by the windshield 101 as a display medium is visually recognized by a user 200 as a driver.

In other words, the user 200 visually recognizes a virtual image 310 projected onto a target space 400 set in front of the automobile 100 through the windshield 101. The “virtual image” in the present disclosure means an image formed as if an object is actually present by reflected light when the light emitted from the head-up display is reflected by a reflecting object such as a windshield. Therefore, as illustrated in FIG. 2, the user 200 who is driving the automobile 100 can see the virtual image 310 projected by the head-up display 1 so as to be superimposed on the real space spreading in front of the automobile 100.

Therefore, the head-up display 1 can display, as the virtual image 310, various kinds of driving assistance information such as, for example, vehicle speed information, navigation information, pedestrian information, forward vehicle information, lane departure information, and a vehicle condition, and cause the user 200 to visually recognize the driving assistance information. In FIG. 2, the virtual image 310 is navigation information, and as an example, displays an arrow indicating a lane change. Thus, the user 200 can visually acquire the driving assistance information with only a slight movement of the line of sight from a state in which the line of sight is directed to the front of the windshield 101.

In the head-up display 1, the virtual image 310 formed in the target space 400 is formed on a virtual plane 501 intersecting an optical axis 500 of the head-up display 1. In the present embodiment, the optical axis 500 is along a road surface 600 in front of the automobile 100 in the target space 400 in front of the automobile 100. The virtual plane 501 on which the virtual image 310 is formed is substantially perpendicular to the road surface 600. For example, when the road surface 600 is a horizontal plane, the virtual image 310 is displayed along a vertical plane. Note that the virtual plane 501 on which the virtual image 310 is formed may be inclined with respect to the optical axis 500. The inclination angle of the virtual plane 501 with respect to the optical axis 500 is not particularly limited.

Configuration of Head-Up Display

A configuration of the head-up display 1 will now be described with reference to FIG. 3. As illustrated in FIG. 3, the head-up display 1 includes the display device 10 and a projection optical system 20. The display device 10 and the projection optical system 20 will be described in detail below.

Configuration of Projection Optical System

The projection optical system 20 is configured to reflect light forming an image of the display device 10 toward the windshield 101 and project the image onto the windshield 101 to project the virtual image 310 onto the target space 400. As illustrated in FIG. 3, the projection optical system 20 includes a first optical member 20a and a second optical member 20b. The first optical member 20a is, for example, a mirror that reflects light from the display device 10 toward the second optical member 20b. The second optical member 20b is, for example, a mirror that reflects light from the first optical member 20a toward the windshield 101. As described above, the projection optical system 20 projects the image of the display device 10 onto the windshield 101 by the first optical member 20a and the second optical member 20b, thereby projecting the virtual image 310 onto the target space 400.

Configuration of Display Device

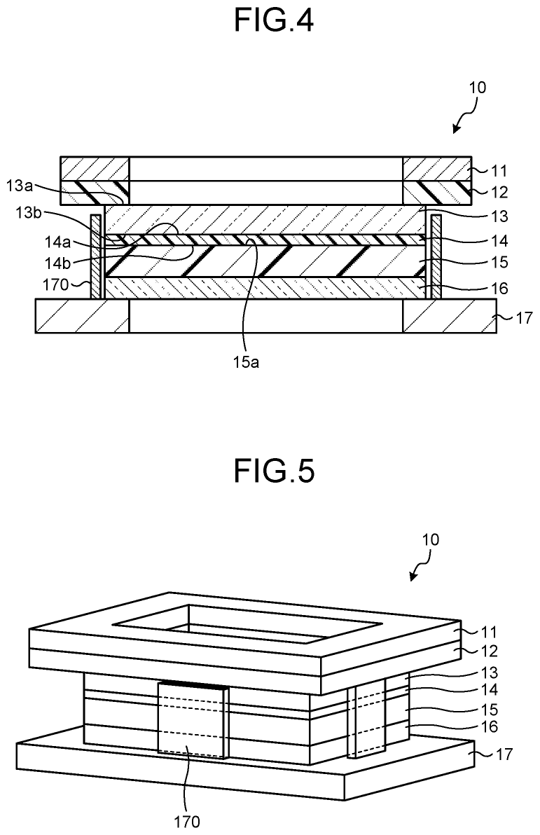

A configuration of the display device 10 will now be described. As illustrated in FIGS. 4 and 5, the display device 10 includes a display member 15, a film member 14, a light transmission member 13, a light diffusion member 16, a pressing member 11, and a frame body 17. Each member constituting the display device 10 will be described below.

The display member 15 has a display surface 15a. Specifically, the display member 15 is a liquid crystal panel, an organic EL panel, or the like. In particular, when the display member 15 is composed of a liquid crystal panel, the display member 15 forms an image on the display surface 15a by selectively transmitting light from backlight. The outer peripheral shape of the display member 15 is rectangular, and the display member 15 is a flat plate-shaped member. In particular, the display member 15 has the display surface 15a which is a surface for displaying an image. The display surface 15a is a region corresponding to a light transmission portion which is a portion that selectively transmits light.

The light transmission member 13 has light transparency and has a thermal conductivity higher than that of quartz crystal. As illustrated in FIG. 4, the light transmission member 13 is disposed on the display surface 15a side of the display member 15. The “thermal conductivity” used in the present disclosure is a physical quantity representing the ease of heat transfer, and in the present embodiment, refers to a value of thermal conductivity measured when the ambient temperature of the environment in which the light transmission member 13 is placed is 20° C.

The light transmission member 13 has a function of improving the heat dissipation of the display device 10. More specifically, for example, when sunlight is condensed on the display surface 15a of the display member 15 from the outside via the projection optical system 20, the light transmission member 13 can efficiently release heat that is generated on the display surface 15a to the outside of the display device 10, and can improve the heat dissipation of the display device 10. Thus, the light transmission member 13 can suppress the temperature rise of the display member 15. The light transmission member 13 has a higher thermal conductivity than quartz crystal. As an example, sapphire glass or the like can be used as the light transmission member 13. As with the display member 15, the light transmission member 13 is a flat plate-shaped member and has a rectangular outer peripheral shape. In the present embodiment, the light transmission member 13 has the same size as the display member 15. However, the light transmission member 13 does not necessarily have the same size as the display member 15. The size of the light transmission member 13 can be reduced within a range in which the heat dissipation function of the light transmission member 13 is not inhibited. The size of the light transmission member 13 may be increased within a range in which the light transmission member does not interfere with other members of the display device 10.

The light transmission member 13 is configured to have two surfaces having different light transmittance. Specifically, the light transmittance of a first surface 13a of the light transmission member 13 on the side opposite to the display member 15 is lower than the light transmittance of a second surface 13b of the light transmission member 13 on the display member 15 side. For example, a black film is vapor-deposited on the first surface 13a of the light transmission member 13. Thus, the light absorptance of the first surface 13a of the light transmission member 13 can be increased, and the light transmittance of the first surface 13a can be made lower than the light transmittance of the second surface 13b of the light transmission member 13.

Note that the first surface 13a of the light transmission member 13 may be roughened by forming fine irregularities, and the haze of the first surface 13a may be greater than the haze of the second surface 13b of the light transmission member 13. The haze is a value obtained by converting the degree of light scattering into a numerical value, which indicates that the larger the haze value is, the cloudier the surface is. Thus, the proportion of light scattered at the first surface 13a of the light transmission member 13 can be increased, and the light transmittance of the first surface 13a can be made lower than the light transmittance of the second surface 13b of the light transmission member 13. The light reflectance of the first surface 13a of the light transmission member 13 may be higher than the light reflectance of the second surface 13b of the light transmission member 13. Thus, the light transmittance of the first surface 13a of the light transmission member 13 can be made lower than the light transmittance of the second surface 13b of the light transmission member 13.

The film member 14 is a film-shaped member having light transparency. As illustrated in FIG. 4, the film member 14 is disposed between the display member 15 and the light transmission member 13. The film member 14 is, as an example, a resin film made of TAC or the like. As with the display member 15 and the light transmission member 13, the film member 14 has a rectangular outer peripheral shape. In the present embodiment, the film member 14 has the same size as the display member 15 and the light transmission member 13. However, the film member 14 does not necessarily have the same size as the display member 15 and the light transmission member 13. For example, the film member 14 may be smaller in size than the display member 15 and the light transmission member 13. When the display member 15 and the light transmission member 13 have different sizes, the film member 14 may have the same size as the smaller one of the display member 15 and the light transmission member 13.

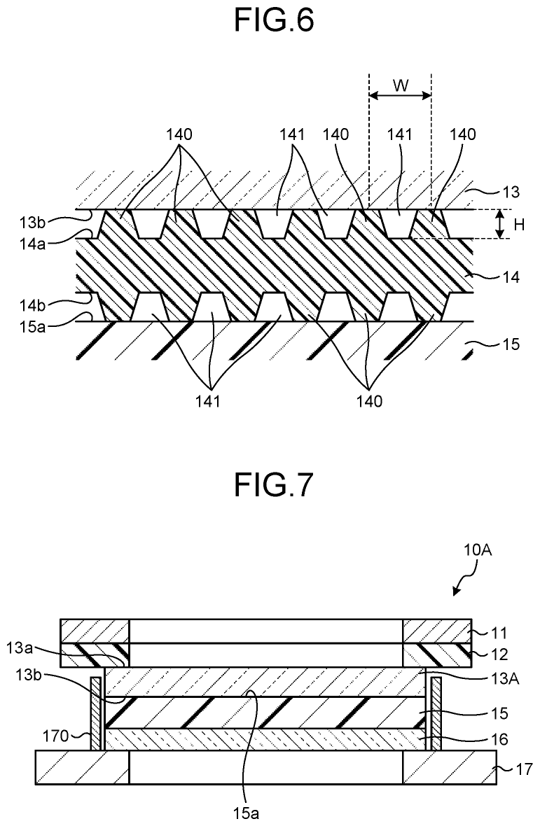

As illustrated in FIG. 6, the film member 14 has a plurality of fine protrusions 140 on the surface of the film member. More specifically, the plurality of protrusions 140 is on a first surface 14a of the film member 14 on the light transmission member 13 side and a second surface 14b of the film member 14 on the display member 15 side. The plurality of protrusions 140 is present on the surface of the film member 14 so as to cover the entire light transmission portion of the display member 15.

The film member 14 is configured to be in contact with the display member 15 and the light transmission member 13 with the plurality of protrusions 140 interposed therebetween. Therefore, a plurality of gaps 141 is formed between the film member 14 and the display member 15 and between the film member 14 and the light transmission member 13 by the plurality of protrusions 140 being in contact with the flat surfaces of the display member 15 and the light transmission member 13. Thus, light transmitted through the film member 14 is diffused, whereby the occurrence of interference of light can be suppressed.

The plurality of protrusions 140 is separated from each other in the planar direction. Although not illustrated, the protrusions 140 may be separated from each other in one direction along the plane, or may be separated from each other in a plurality of directions along the plane. The average interval W (see FIG. 6) between the protrusions 140 is, as an example, 5 μm or more and 500 μm or less. The height H (see FIG. 6) of each of the protrusions 140 is, as an example, 0.5 μm or more and 250 μm or less.

The film member 14 may be configured to have a refractive index larger than the refractive index of the display member 15 and smaller than the refractive index of the light transmission member 13. In other words, if the refractive index of the display member 15 is F1, the refractive index of the light transmission member 13 is F2, and the refractive index of the film member 14 is F3, then F1, F2, and F3 satisfy the following conditional expression (1). Note that F1, F2, and F3 may not satisfy the following conditional expression (1).

F1≤F3<F2 (1)

The pressing member 11 is a member that presses the light transmission member 13 toward the display surface 15a. The pressing member 11 is a rectangular plate-shaped member and has a rectangular opening at a position corresponding to the display region of the display member 15. In other words, the pressing member 11 is a frame-shaped member and has a rectangular outer peripheral shape in plan view. The pressing member 11 is in contact with a portion of the light transmission member 13 corresponding to a region other than the display region of the display member 15. The pressing member 11 is disposed on the side opposite to the display member 15 with respect to the light transmission member 13, and presses the light transmission member 13 against the display member 15 by coming into contact with the light transmission member 13 from the side opposite to the display member 15. The pressing member 11 is thermally conductive. The thermal conductivity of the pressing member 11 is preferably higher than the thermal conductivity of the light transmission member 13. The pressing member 11 is made of, for example, aluminum.

The pressing member 11 may press the light transmission member 13 with a buffer member 12 interposed therebetween. In this case, the buffer member 12 is disposed between the pressing member 11 and the light transmission member 13. The buffer member 12 is elastic. As with the pressing member 11, the buffer member 12 is a plate-shaped member, has a rectangular outer peripheral shape in plan view, and further has a rectangular opening. In other words, the buffer member 12 is a frame-shaped member and has a rectangular outer peripheral shape. The thermal conductivity of the buffer member 12 is preferably higher than the thermal conductivity of the light transmission member 13.

As illustrated in FIG. 4, the light diffusion member 16 is provided on the side of the display member 15 opposite to the display surface 15a. The light diffusion member 16 has a function of diffusing light from a light source (not illustrated) to guide the light to the display member 15, and thus improving the uniformity ratio of illumination on the display surface 15a of the display member 15. The outer peripheral shape of the light diffusion member 16 is rectangular in plan view, and the light diffusion member 16 is a plate-shaped member. The light diffusion member 16 has light transparency. The material of the light diffusion member 16 includes, for example, PET or glass. The light diffusion member 16 is preferably not thermally insulative. The light diffusion member 16 preferably has a size that covers the light transmission portion of the display member 15.

The light diffusion member 16 is configured to have haze higher than the haze of the film member 14. The haze of the film member 14 is set to be higher than the haze of the second surface 13b of the light transmission member 13. In other words, if the haze of the second surface 13b of the light transmission member 13 is H1, the haze of the film member 14 is H2, and the haze of the light diffusion member 16 is H3, then H1, H2, and H3 satisfy the following conditional expression (2).

H1<H2<H3 (2)

The haze of the film member 14 is preferably 1% to 15%. If the haze is less than 1%, the effect of reducing Newton's rings may not be sufficiently obtained. On the other hand, if the haze is greater than 15%, the luminance of the light emitted from the display member 15 may decreases, and the visibility of the virtual image may decrease.

The frame body 17 is provided to attach the display member 15. The frame body 17 is disposed so as to be in contact with a peripheral edge of a surface of the light diffusion member 16 opposite to the display member 15. The frame body 17 preferably has a higher thermal conductivity than the light transmission member 13 and the light diffusion member 16. The frame body 17 is made of, for example, aluminum. By constituting the frame body 17 in such a manner, the heat dissipation of the display device 10 can be easily improved. Note that if the heat of the display member 15 can be sufficiently released by the pressing member 11, the frame body 17 may be formed of a resin or the like. The outer peripheral shape of the frame body 17 is rectangular in plan view, and the frame body 17 is a tubular member and has a plurality of (here, four) holding parts 170. As illustrated in FIG. 5, each of the holding parts 170 relatively fixes the light transmission member 13, the display member 15, and the light diffusion member 16 relative to the frame body 17. More specifically, when the light transmission member 13, the film member 14, the display member 15, and the light diffusion member 16 are regarded as one rectangular parallelepiped member, four holding parts 170 are disposed so as to face four side surfaces of the rectangular parallelepiped member, respectively. The four holding parts 170 allows this rectangular parallelepiped member to be relatively fixed relative to the frame body 17.

In the display device 10, as described above, the light transmission member 13, the display member 15, and the light diffusion member 16 are held by the plurality of holding parts 170 of the frame body 17. The pressing member 11 is in contact with the light transmission member 13 directly or with the buffer member 12 interposed therebetween. In other words, heat that is generated in the display surface 15a of the display member 15 is transmitted to the pressing member 11 via the light transmission member 13, and is dissipated to the outside air.

### Effects and Others

As described above, in the present embodiment, the display device 10 includes the display member 15, the film member 14, the light transmission member 13, and the light diffusion member 16. The plurality of protrusions 140 is formed on the surface of the film member 14. The plurality of gaps 141 is formed between the film member 14 and the display member 15 and between the film member 14 and the light transmission member 13 by the plurality of protrusions 140 being in contact with the flat surfaces of the display member 15 and the light transmission member 13.

Thus, the occurrence of Newton's rings can be reduced in the display device 10. When the smooth display surface 15a of the display member 15 and the smooth surface of the light transmission member 13 are brought into close contact with each other, an air layer is formed between the display member 15 and the light transmission member 13 because these surfaces are not actually perfect planes. Thus, an interface at which the refractive index greatly changes is present, and a phase shift or an optical path length change due to fixed-end reflection occurs, whereby interference of light occurs, and Newton's rings may occur. According to the display device 10 of the present embodiment, since the film member 14 having the plurality of protrusions 140 is disposed between the display member 15 and the light transmission member 13, the smooth surfaces are not in close contact with each other, and the light transmitted through the film member 14 is diffused, whereby the occurrence of interference of light can be suppressed and the occurrence of Newton's rings can be reduced.

In addition, if the haze of the second surface 13b of the light transmission member 13 is H1, the haze of the film member 14 is H2, and the haze of the light diffusion member 16 is H3, then H1, H2, and H3 satisfy the following conditional expression (2).

H1<H2<H3 (2)

Thus, it is possible to achieve both a reduction in the occurrence of Newton's rings and suppression of a deterioration in image quality. If the haze H2 of the film member 14 is increased, the effect of reducing the occurrence of Newton's rings is expected to be enhanced, but in the display device 10 of the present embodiment, the light transmission member 13 is disposed on the display surface 15a side of the display member 15. Therefore, if the haze H2 of the film member 14 that is disposed between the display member 15 and the light transmission member 13 is increased, the image quality of the image displayed on the display surface 15a of the display member 15 may be deteriorated. In the display device 10 of the present embodiment, the haze H2 of the film member 14 is made greater than the haze H1 of the second surface 13b of the light transmission member 13, and the haze H2 of the film member 14 is made less than the haze H3 of the light diffusion member 16, whereby a deterioration in image quality can be suppressed while reducing the occurrence of Newton's rings.

The light transmittance of the first surface 13a of the light transmission member 13 is lower than the light transmittance of the second surface 13b of the light transmission member 13.

Thus, even if external light such as sunlight enters the head-up display 1 and reaches the display device 10, a part of the external light can be absorbed or reflected on the first surface 13a of the light transmission member 13, so that the external light reaching the display member 15 can be reduced, and the temperature rise of the display member 15 can be suppressed.

The light transmission member 13 is disposed on the display surface 15a side of the display member 15.

Thus, even if the display surface 15a of the display member 15 is heated by external light such as sunlight entering the head-up display 1, the heat can be dissipated through the light transmission member 13, and the temperature rise of the display member 15 can be suppressed.

If the refractive index of the display member 15 is F1, the refractive index of the light transmission member 13 is F2, and the refractive index of the film member 14 is F3, then F1, F2, and F3 satisfy the following conditional expression (1).

F1≤F3<F2 (1)

Thus, deterioration in image quality can be suppressed. As the light transmission member 13, sapphire glass having high thermal conductivity is preferably used, but since the refractive index of sapphire glass is about 1.77 with respect to light having a wavelength of 550 nanometers, the difference in refractive index between the display member 15 and the light transmission member 13 increases, and the image quality may be affected. In the display device 10 of the present embodiment, the film member 14 having a refractive index of an intermediate value between the respective refractive indices F1 and F2 of the display member 15 and the light transmission member 13 is disposed between the display member 15 and the light transmission member 13, whereby a deterioration in image quality can be suppressed while suppressing the temperature rise of the display member 15.

### Second Embodiment

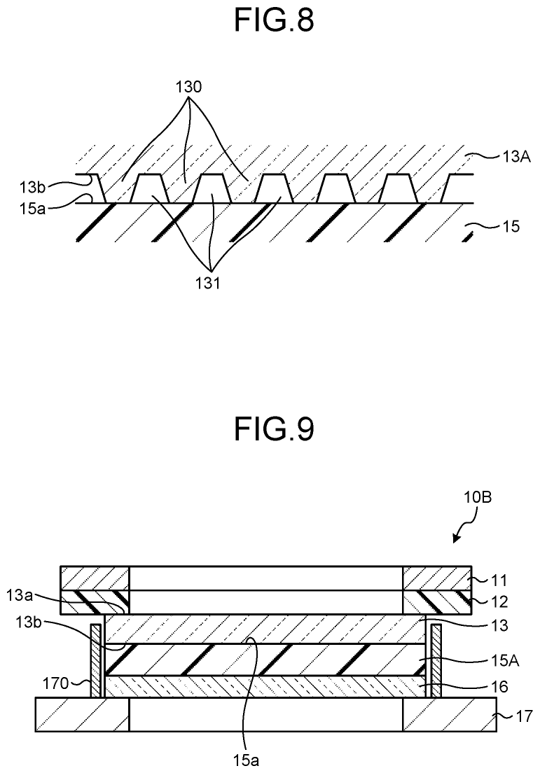

A second embodiment will be described below with reference to FIGS. 7 and 8. Note that the same members as those in the first embodiment described above are denoted by the same reference numerals, and the description thereof will be omitted.

As illustrated in FIG. 7, a display device 10A includes a display member 15, a light transmission member 13A, a light diffusion member 16, a pressing member 11, and a frame body 17. Unlike the case of the display device 10, the display device 10A does not include a film member 14. Instead, as illustrated in FIG. 8, the light transmission member 13A has a plurality of protrusions 130. More specifically, the plurality of protrusions 130 is on the second surface 13b of the light transmission member 13A. The plurality of protrusions 130 is present on the second surface 13b of the light transmission member 13A so as to cover the entire light transmission portion of the display member 15.

The light transmission member 13A is configured to be in contact with the display member 15 with the plurality of protrusions 130 interposed therebetween. Therefore, a plurality of gaps 131 is formed between the light transmission member 13A and the display member 15 by the plurality of protrusions 130 being in contact with the flat surface of the display member 15.

Thus, in the display device 10A, since the plurality of protrusions 130 is present between the light transmission member 13A and the display member 15, the smooth surfaces are not in close contact with each other, and the light reflected by the second surface 13b of the light transmission member 13A and the light transmitted through the second surface 13b are diffused, whereby the occurrence of interference of light can be suppressed and the occurrence of Newton's rings can be reduced. In the display device 10A, since it is not necessary to use a separate member such as the film member 14 in order to provide the plurality of protrusions 130, heat that is generated in the display member 15 can be directly transferred to the light transmission member 13A, and heat dissipation can be improved.

### Third Embodiment

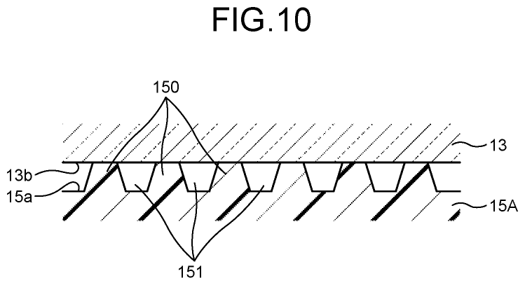

A third embodiment will be described below with reference to FIGS. 9 and 10. Note that the same members as those in the first and second embodiments described above are denoted by the same reference numerals, and the description thereof will be omitted.

As illustrated in FIG. 9, a display device 10B includes a display member 15A, a light transmission member 13, a light diffusion member 16, a pressing member 11, and a frame body 17. The display device 10B does not include a film member 14, as in the case of the display device 10A of the second embodiment described above. Instead, as illustrated in FIG. 10, the display member 15A has a plurality of protrusions 150. More specifically, the plurality of protrusions 150 is on the display surface 15a of the display member 15A. The plurality of protrusions 150 is present throughout the entire light transmission portion of the display member 15A.

The display member 15A is configured to be in contact with the light transmission member 13 with the plurality of protrusions 150 interposed therebetween. Therefore, a plurality of gaps 151 is formed between the light transmission member 13 and the display member 15A by the plurality of protrusions 150 being in contact with the flat surface of the light transmission member 13.

Thus, in the display device 10B, since the plurality of protrusions 150 is present between the light transmission member 13 and the display member 15A, the smooth surfaces are not in close contact with each other, and the light reflected by the display surface 15a of the display member 15A is diffused, whereby the occurrence of interference of light can be suppressed and the occurrence of Newton's rings can be reduced. In the display device 10B, since it is not necessary to use a separate member such as the film member 14 in order to provide the plurality of protrusions 150, heat that is generated in the display member 15A can be directly transferred to the light transmission member 13, and heat dissipation can be improved.

### Other Embodiments

As described above, the first to third embodiments have been described as examples of the techniques disclosed in the present application. However, the technique in the present disclosure is not limited thereto, and can also be applied to embodiments in which changes, replacements, additions, omissions, and the like have been made. The components described in the first to third embodiments may be combined to form a new embodiment.

For example, in the display device 10 of the first embodiment, the film member 14 may not have the plurality of protrusions 140 on both the first surface 14a and the second surface 14b. In other words, the plurality of protrusions 140 may be provided only on the second surface 14b of the film member 14. In this case, the first surface 14a of the film member 14 may be a flat surface. Alternatively, the plurality of protrusions 140 may be provided only on the first surface 14a of the film member 14. In this case, the second surface 14b of the film member 14 may be a flat surface.

In the display device 10 of the first embodiment, the light transmission member 13 may not have two surfaces having different light transmittance. In other words, the light transmittance of the first surface 13a of the light transmission member 13 may be the same as the light transmittance of the second surface 13b of the light transmission member 13. Alternatively, the light transmittance of the first surface 13a of the light transmission member 13 may be higher than the light transmittance of the second surface 13b of the light transmission member 13.

In the display device 10 of the present embodiment, when the plurality of protrusions 140 (130, 150) is in contact with a flat surface of the display member 15 or the light transmission member 13, the plurality of protrusions 140 (130, 150) and the flat surface may be joined to each other with an adhesive or may be in contact with each other without using an adhesive. Note that it is preferable not to use an adhesive. This is because when an adhesive is used, hydrolysis occurs, for example, at the interface between the adhesive and the flat surface of the display member 15 or the light transmission member 13, and the image quality may be deteriorated. When the adhesive is not used, the occurrence of such hydrolysis can be suppressed, and the plurality of protrusions 140 (130, 150) comes into contact with the flat surface of the display member 15 or the light transmission member 13, whereby the occurrence of Newton's rings can be reduced.

The display device 10 (10A, 10B) may not include the pressing member 11 and the buffer member 12. Alternatively, the display device may have a configuration including the buffer member 12 and not including the pressing member 11. In this case, the display device is preferably configured such that the light transmission member 13 (13A) is joined to a member having heat dissipation capability directly or with the buffer member 12 interposed therebetween. For example, the display device 10 (10A, 10B) may not include the light diffusion member 16.

The outer peripheral shapes of the components of the display device 10 (10A, 10B) are not particularly limited. As an example, the outer peripheral shapes of the display member 15 (15A), the film member 14, the light transmission member 13 (13A), and the light diffusion member 16 are not necessarily rectangular in plan view, and may be circular, square, or other polygonal shapes.

The head-up display 1 may include a hologram element instead of the projection optical system 20. In this case, the light emitted from the display device 10 (10A, 10B) is incident on the hologram element, and the light diffracted by the hologram element is emitted toward the windshield 101.

In the above embodiments, the windshield 101 has been described as an example of the display medium. The display medium may have any configuration as long as the display medium reflects the image projected from the head-up display 1 and causes the user 200 to visually recognize the image. The display medium may be realized with a combiner that is present between the windshield 101 and the user 200.

### SUMMARY

As is apparent from the above embodiments, the present disclosure includes the following aspects. In the following description, reference numerals are given in parentheses, only in order to clearly illustrate the correspondence with the embodiments.

A display device (10, 10A, 10B) of a first aspect includes a display member (15, 15A), a light transmission member (13, 13A), and a light diffusion member (16). The display member (15, 15A) has a display surface (15a). The light transmission member (13, 13A) is disposed on the display surface (15a) side of the display member (15, 15A), has a first surface (13a) on the side opposite to the display member (15, 15A) and a second surface (13b) on the display member side, and has light transparency. The light diffusion member (16) is disposed on the side opposite to the display surface (15a) of the display member (15, 15A), and has light diffusion. The display device (10, 10A, 10B) has a plurality of protrusions (130, 140, 150) that is provided between the light transmission member (13, 13A) and the display member (15, 15A). According to the first aspect, a plurality of gaps (131, 141, 151) is formed by at least one flat surface of the light transmission member (13, 13A) or the display member (15, 15A) being in contact with the plurality of protrusions (130, 140, 150). Therefore, the occurrence of Newton's rings can be reduced.

A display device (10, 10A, 10B) of a second aspect may be realized in combination with the first aspect. In the second aspect, the plurality of protrusions (130, 140, 150) is provided between the light transmission member (13, 13A) and the display member (15, 15A) so as to be separated from each other. According to the second aspect, the plurality of gaps (131, 141, 151) is more reliably formed by at least one flat surface of the light transmission member (13, 13A) or the display member (15, 15A) being in contact with the plurality of protrusions (130, 140, 150). Therefore, the occurrence of Newton's rings can be reduced.

A display device (10) of a third aspect may be realized in combination with the first or second aspect. In the third aspect, the display device (10) further includes a film member (14). The film member (14) is disposed between the display member (15) and the light transmission member (13). The plurality of protrusions (140) is provided on a surface (14a, 14b) of the film member (14). According to the third aspect, the plurality of gaps (141) is formed by at least one flat surface of the light transmission member (13) or the display member (15) being in contact with the plurality of protrusions (140) provided on the film member (14). Therefore, the occurrence of Newton's rings can be reduced.

A display device (10) of a fourth aspect may be realized in combination with the third aspect. In the fourth aspect, the haze H1 of a second surface (13b) of the light transmission member (13), the haze H2 of the film member (14), and the haze H3 of the light diffusion member (16) satisfy the following conditional expression (2). According to the fourth aspect, a deterioration in image quality can be suppressed while reducing the occurrence of Newton's rings.

H1<H2<H3 (2)

A display device (10, 10A, 10B) of a fifth aspect may be realized in combination with any one of the first to fourth aspects. In the fifth aspect, the light transmittance of the first surface (13a) of the light transmission member (13, 13A) is lower than the light transmittance of the second surface (13b) of the light transmission member (13, 13A). According to the fifth aspect, a part of external light such as sunlight reaching the display device (10, 10A, 10B) is not transmitted through the first surface (13a) of the light transmission member (13, 13A). Therefore, the temperature rise of the display member (15, 15A) can be suppressed.

A display device (10, 10A, 10B) of a sixth aspect may be realized in combination with the fifth aspect. In the sixth aspect, the light absorptance of the first surface (13a) of the light transmission member (13, 13A) is higher than the light absorptance of the second surface (13b) of the light transmission member (13, 13A). According to the sixth aspect, a part of external light such as sunlight reaching the display device (10, 10A, 10B) can be absorbed by the first surface (13a) of the light transmission member (13, 13A). Therefore, the temperature rise of the display member (15, 15A) can be suppressed.

A display device (10, 10A, 10B) of a seventh aspect may be realized in combination with the fifth aspect. In the seventh aspect, the haze of the first surface (13a) of the light transmission member (13, 13A) is greater than the haze of the second surface (13b) of the light transmission member (13, 13A). According to the seventh aspect, a part of external light such as sunlight reaching the display device (10, 10A, 10B) can be scattered by the first surface (13a) of the light transmission member (13, 13A). Therefore, the temperature rise of the display member (15, 15A) can be suppressed.

A display device (10A) of an eighth aspect may be realized in combination with the first or second aspect. In the eighth aspect, the plurality of protrusions (130) is provided on the second surface (13b) of the light transmission member (13A). According to the eighth aspect, the plurality of gaps (131) is formed by the flat surface of the display member (15) and the plurality of protrusions (130) provided on the light transmission member (13A) being in contact with each other. Therefore, the occurrence of Newton's rings can be reduced.

A display device (10B) of a ninth aspect may be realized in combination with the first or second aspect. In the ninth aspect, the plurality of protrusions (150) is provided on the display surface (15a) of the display member (15A). According to the ninth aspect, the plurality of gaps (151) is formed by the flat surface of the light transmission member (13) and the plurality of protrusions (150) provided on the display member (15A) being in contact with each other. Therefore, the occurrence of Newton's rings can be reduced.

A head-up display (1) of a tenth aspect includes: a display device (10, 10A, 10B) of any one of the first to ninth aspects; and a projection optical system (20) that projects display light emitted from the display device (10, 10A, 10B) onto a display media (101). According to the tenth aspect, it is possible to reduce the occurrence of Newton's rings in the display device (10, 10A, 10B).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display device comprising:
a display member having a display surface;
a light transmission member that is disposed on the display surface side of the display member, the light transmission member having light transparency and having a first surface on a side opposite to the display member and a second surface on the display member side;
a light diffusion member that is disposed on a side opposite to the display surface of the display member, the light diffusion member having light diffusion; and
a plurality of protrusions that is provided between the light transmission member and the display member.

2. The display device according to claim 1, wherein
the plurality of protrusions is provided between the light transmission member and the display member to be separated from each other.

3. The display device according to claim 1, further comprising:
a film member that is disposed between the display member and the light transmission member, wherein
the plurality of protrusions is provided on a surface of the film member.

4. The display device according to claim 3, wherein
a haze H1 of the second surface of the light transmission member, a haze H2 of the film member, and a haze H3 of the light diffusion member satisfy a following conditional expression (1):
H1<H2<H3 (1).

5. The display device according to claim 1, wherein
a light transmittance of the first surface of the light transmission member is lower than a light transmittance of the second surface of the light transmission member.

6. The display device according to claim 5, wherein
a light absorptance of the first surface of the light transmission member is higher than a light absorptance of the second surface of the light transmission member.

7. The display device according to claim 5, wherein
a haze of the first surface of the light transmission member is greater than a haze of the second surface of the light transmission member.

8. The display device according to claim 1 wherein
the plurality of protrusions is provided on the second surface of the light transmission member.

9. The display device according to claim 1, wherein
the plurality of protrusions is provided on the display surface of the display member.

10. A head-up display comprising:
a display device; and
a projection optical system configured to project display light emitted from the display device onto a display medium,
the display device comprising:
a display member having a display surface;
a light transmission member that is disposed on the display surface side of the display member, the light transmission member having light transparency and having a first surface on a side opposite to the display member and a second surface on the display member side;
a light diffusion member that is disposed on a side opposite to the display surface of the display member, the light diffusion member having light diffusion; and
a plurality of protrusions that is provided between the light transmission member and the display member.

11. The head-up display according to claim 10, wherein
the plurality of protrusions is provided between the light transmission member and the display member to be separated from each other.

12. The head-up display according to claim 10, further comprising:
a film member that is disposed between the display member and the light transmission member, wherein
the plurality of protrusions is provided on a surface of the film member.

13. The head-up display according to claim 12, wherein
a haze H1 of the second surface of the light transmission member, a haze H2 of the film member, and a haze H3 of the light diffusion member satisfy a following conditional expression (1):
H1<H2<H3 (1).

14. The head-up display according to claim 10, wherein
a light transmittance of the first surface of the light transmission member is lower than a light transmittance of the second surface of the light transmission member.

15. The head-up display according to claim 14, wherein
a light absorptance of the first surface of the light transmission member is higher than a light absorptance of the second surface of the light transmission member.

16. The head-up display according to claim 14, wherein
a haze of the first surface of the light transmission member is greater than a haze of the second surface of the light transmission member.

17. The head-up display according to claim 10, wherein
the plurality of protrusions is provided on the second surface of the light transmission member.

18. The head-up display according to claim 10, wherein
the plurality of protrusions is provided on the display surface of the display member.
